(19) United States
(12) Patent Application Publication
(10) Pub. No.: US 2007/0164066 A1
(43) Pub. Date: Jul. 19, 2007

(54) Vehicle top carrier with gull wing doors

(76) Inventor: Peter Jones, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/595,811

(22) Filed: Nov. 8, 2006

Related U.S. Application Data
(60) Provisional application No. 60/734,891, filed on Nov. 8, 2005.

(51) Int. Cl. B60R 9/055; B60R 9/00

(52) U.S. Cl. 224/328

(57) ABSTRACT

Assemblies for carrying cargo items on a vehicle. In particular, improvements for vehicle top carriers designed for mounting on the roof of a vehicle and transporting sporting goods or other cargo.

### CROSS REFERENCE TO RELATED APPLICATIONS

This application is based upon and claims priority under 35 U.S.C. § 119 from U.S. Provisional Patent Application Ser. No. 60/734,891 filed Nov. 8, 2005, which is incorporated herein by reference in its entirety for all purposes.

This application also incorporates by reference in their entirety for all purposes the following U.S. patents: U.S. Pat. No. 6,905,053 issued Jun. 14, 2005; and U.S. Pat. No. 6,918,521 issued Jul. 19, 2005. This application also incorporates by reference in their entirety for all purposes the following U.S. patent applications: Ser. No. 10/767,398 filed Jan. 28, 2004; Ser. No. 11/152,674, filed Jun. 13, 2005; Ser. No. 60/695,977 filed Jul. 1, 2005; Ser. No. 11/219,578 filed Sep. 2, 2005; Ser. No. 60/729,503 filed Oct. 21, 2005; Ser. No. 60/740,705 filed Nov. 29, 2005; and U.S. Provisional patent application Ser. No. ______ filed Nov. 1, 2006 titled “Car Top Carrier Lid Support”.

### FIELD OF THE INVENTION

The present disclosure relates to assemblies for carrying cargo items on a vehicle. In particular, the invention provides improvements for cargo boxes or cargo trunks, collectively termed vehicle top carriers, designed for mounting on the roof of a vehicle and transporting sporting goods or other cargo.

### BACKGROUND

Vehicle top carriers, such as cargo boxes or cargo trunks, have become quite popular in recent years. Enclosed carriers may be preferable over conventional open racks for a variety of reasons. For example, enclosed carriers protect cargo items from the elements such as wind, rain, and snow. Additionally, enclosed carriers may be more secure from theft or vandalism. Yet another advantage is that enclosed carriers may allow items to be fixed to the carrier in a simpler, less elaborate manner than exposed cargo roof racks, since security and stability for items within the carrier is provided partially by the carrier itself.

However, some car top boxes have problems that make them difficult or cumbersome to use. For example, some enclosed car top carriers can only be accessed from one side, or from one side at a time. Depending upon where or how the vehicle is parked, or upon who is trying to access the carrier, a user may find it inconvenient or awkward always to access the box from the same side. Moreover, items stored on one side of the carrier may be difficult to access from the other side of the carrier.

Another problem with car top trunks or boxes is that they are sometimes difficult to open. Typically, there are several latches on the side of the box that opens. The user may have to operate multiple latches simultaneously, and the latches may be separated by a long distance. This may require substantial strength, dexterity, and reach. Some boxes have an actuator that coordinates simultaneous release of multiple latches, but this configuration still may require special handling such as lifting of the cover while manipulating the actuator or handle.

Yet another problem with car top trunks or boxes is that it is difficult for a user to gauge how much room remains in the carrier when the box is opened. Typically, the entire top lid of the carrier pivots upwardly from the base into an angled position on either side of the carrier. This provides access to remove items from the carrier, or to place items inside, but leaves no visual indication of the height of the top lid. It is not uncommon for too many items to be placed into the base such that the top lid cannot be properly latched closed.

Yet another problem with car top trunks or boxes is that the top lid, when functioning as the door to allow access the interior of the carrier, is not stable. In order to provide a maximum amount of storage space, the top lid typically made as large as possible. Since the top lid is typically fabricated from a single piece of a polymer-based material that is form-pressed into a specific shape, the top lid generally flexes slightly, and may be difficult to maneuver under windy conditions or when the vehicle onto which the carrier is mounted is parked on an angled slope. Accordingly, there is a need for improved enclosed car top carriers that are easy to mount on a vehicle and easy to use, and which helps to overcome one or more of the problems described above.

### BRIEF DESCRIPTION OF THE DRAWINGS

FIG. 1 is an isometric view of a car top carrier with a pair of gull wing doors shown in a closed position, according to aspects of the present disclosure.

FIG. 2 is another isometric view of the car top carrier of FIG. 1, where one of the gull wing doors is shown in an open position.

FIG. 3 is an end elevational view of the car top carrier of FIGS. 1 and 2, where both of the gull wing doors are shown in an open position.

FIG. 4 is an isometric view of a torsion bar assembly suitable for use with a car top carrier having gull wing doors, according to aspects of the present disclosure.

FIG. 5 is a magnified isometric view of a portion of the torsion bar assembly of FIG. 4.

FIG. 6 is a sectional end elevational view of a car top carrier with gull wing doors and incorporating a pair of the torsion bar assemblies shown in FIG. 4.

FIG. 7 is an isometric view of the car top carrier of FIG. 6, where the top of the carrier has been depicted as semi-transparent, and where a portion of one of the gull wing doors has been cut away to show one of the torsion bar assemblies.

### DETAILED DESCRIPTION

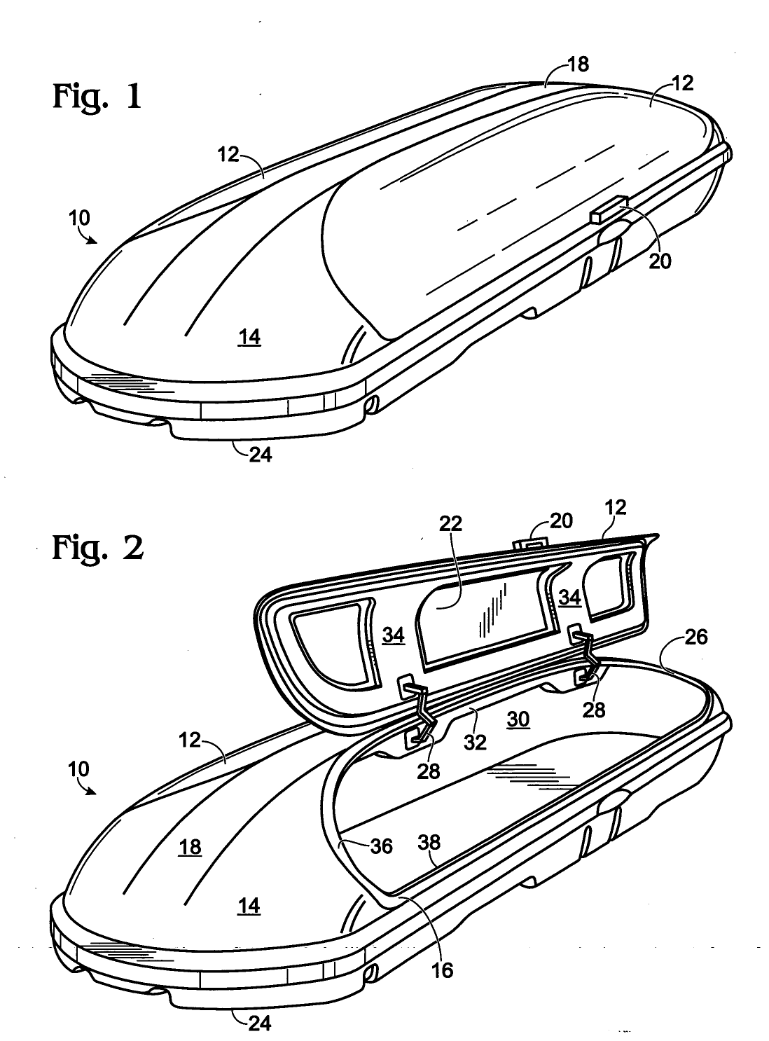

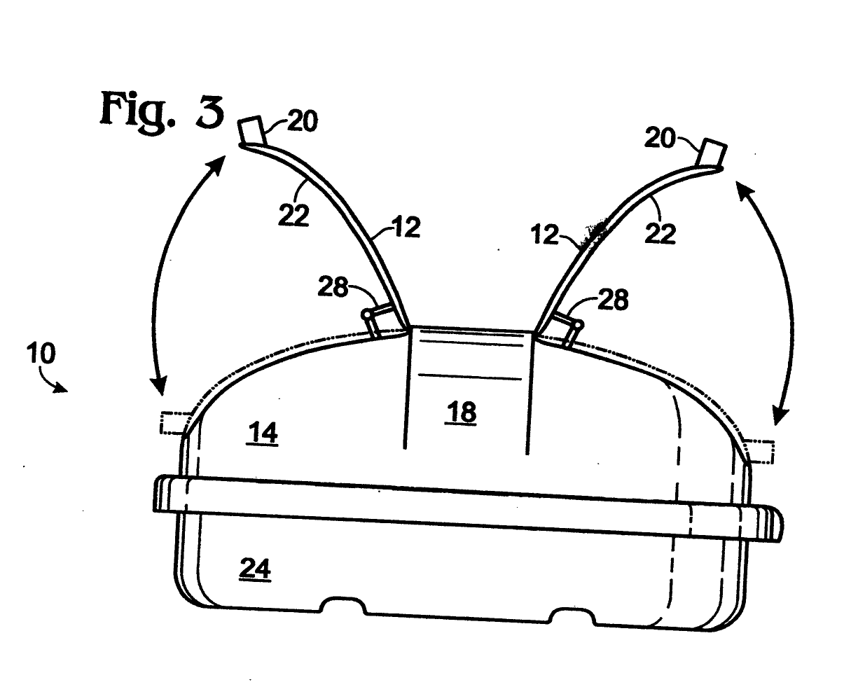

FIGS. 1 and 2 show isometric views of a car top carrier or box 10 with gull wing doors 12, according to aspects of the present disclosure. FIG. 1 shows the carrier with both doors in a closed position, and FIG. 2 shows the carrier with one of the doors closed and the other in an open position. Whereas conventional car-top carriers include a top lid that opens from only one side, or from only one side at a time, to allow access to the contents inside, carrier 10 may include a top lid 14 that has two doors 12 positioned on each side of the box, to allow access to the contents from both sides simultaneously. As FIG. 1 depicts, doors 12 are disposed on opposite sides of box 10, and each door may be opened separately. The doors extend from an outer portion 16 of the top lid toward a central spine or support region 18 of the lid. A handle 20 may be provided to assist a user in conveniently opening and closing each door 12. Alternatively or in addition to handle 20, a loop or strap (not shown), adapted to be pulled by the user to close door 12, may be mounted on an interior surface 22 of each door.

Car top carrier 10 may be designed for attachment to a rack that is positioned on the roof of a car, van, sport utility vehicle, or the like. The rack may include two crossbars that are positioned substantially transverse to the longitudinal axis of the vehicle to which they are mounted. Carrier 10 may include mounting hardware for easily securing carrier 10 to the vehicle rack. Mechanisms for mounting carrier 10 to the cross bars are described, for example, in U.S. patent application Ser. No. 10/767,398 filed Jan. 28, 2004, previously incorporated by reference into the present disclosure.

Cooperatively, doors 12 and central support region 18 of carrier 10 may form top lid 14 of the carrier. The lower portion of top lid 14 may be fixedly mated to a bottom or base member 24 of carrier 10 by fasteners such as screws, bolts or the like, or by welding, gluing, or other suitable techniques. Alternatively, top lid 14 may be removably mated to base member 24 so that a user may conveniently remove and replace the carrier on a vehicle in a tool-free or nearly tool-free manner. Carrier 10 may be available in any number of sizes, depending on its intended use. For example, carriers of 16, 18, or 21 cubic feet may be available. Carrier 10 may include a top lid 14 that has a contoured aerodynamic profile, and accordingly, doors 12 are shown to fit flatly within a door aperture 26 in top lid 14. As a result, the outer surface of doors 12 and central support 18 together may provide a continuous and aerodynamic surface of the carrier.

Each of doors 12 may include a locking mechanism (not shown). In some embodiments, the locking mechanism of each door may be integrated with handle 20, and may be similar in appearance and function to a conventional paddle-shaped car door handle. Locking mechanisms for carrier 10 also may include one or more receptors mounted on the inner surfaces of central support region 18. Additionally or alternatively, carrier 10 may include a single locking mechanism that is adapted to secure both doors simultaneously.

FIGS. 2 and 3 show box 10 with one or more of doors 12 in an open position. FIG. 2 is an isometric view showing one of doors 12 open and one closed, and FIG. 3 is an end elevational view showing both of doors 12 open and illustrating the rotational range of motion of the doors. As seen in FIG. 2, a pair of hinge members 28 is attached to each of doors 12, and each hinge member also is attached to an interior surface 30 of the carrier. The hinge members allow rotation of the door away from central support region 18, and may be configured to provide an upward rotational biasing force during some or all of the rotational motion of each door, to assist a user in opening the door and to hold the door in an open position. In other words, hinge members 28 may act both as a hinge and as a strut.

Doors 12 and interior surface 30 of the carrier may include one or more ribs for strengthening the carrier and supporting the weight of doors 12. For example, as depicted in FIG. 2, a rib 32 may be disposed on an inner portion of central support region 18, and various ribs 34 may be formed on interior surface 22 of doors 12 to structurally strengthen the doors. In various embodiments, ribs 32 formed with or attached to central support region 18 may be disposed longitudinally along the length of top lid 14 at its apex, around the perimeter of top lid 14, around the perimeter of door apertures 26, or in any combination of these or other suitable locations. Furthermore, base member 24 also may include one or more ribs similar to ribs 32. Ribs may provide structural stability to the doors, to the central support including door apertures 26, and/or to the base member. Finally, although FIG. 2 depicts only ribs 32 and 34 formed respectively on the interior surface 30 of carrier 10 and on the interior surface 22 of door 12, alternatively or additionally, ribs may be formed on exterior surfaces of the carrier. This may provide additional structural stability to the carrier, and also may alter the aerodynamic properties of the carrier in desirable ways.

As mentioned previously and as seen in FIG. 2, ribs disposed within box 10, such as central rib 32, may provide a location within the box to attach door mounting hardware such as hinge members 28. As depicted in FIG. 2, the hinge members may include a conventional scissor-style hinge that acts as both a hinge and a strut. Additionally or alternatively, the door hardware may include separate hinges and struts (not shown). For example, the door hardware may include a conventional hinge or any other suitable mechanism to allow doors 12 to pivot freely away from central support region 18, and either a separate or integrated strut, or any other suitable mechanism, to urge door 12 towards the open position and to support the door when open. The hinge mechanism and/or strut may include an over-center mechanism, a gas shock or strut, or a torsion bar assembly, the latter of which will be described in more detail below.

Referring again to FIG. 2, to keep the contents of carrier 10 dry during potential inclement weather, door aperture 26 of the carrier may include an active water barrier formed around the perimeter of the aperture, a passive water barrier similarly formed around the perimeter of the aperture, or both. For example, the perimeter of aperture 26 may include an active water barrier such as, for example, a foam rubber seal 36 that is adapted to prevent water from entering the carrier when doors 12 are closed. Additionally or alternatively, a passive water barrier such as a channel or gutter 38 may be incorporated into door aperture 26. Channel 38 may be adapted to catch any water that penetrates seal 36, or that may flow into door aperture 26 when door 12 is open, and transport the water to a location from which it may flow away without reaching the interior of the carrier. In addition to its utility as a water barrier, channel 38 also may function as a supporting rib for the aperture, in the manner previously described.

Carrier 10 may include additional elements (not shown) to facilitate convenient use of the carrier. For example, top lid 14 or base 24 may be configured with removable and/or adjustable partitions that allow a user to configure storage compartments within the carrier. Base 24 may be outfitted with an internal pad or floor cover adapted to cushion the impact of objects that are placed into the carrier, and/or to dampen noises resulting from objects moving within the carrier while the vehicle to which it is attached is in motion. Top lid 14 or base 24 also may include one or more locations adapted to attach netting or the like, into which small objects can be placed to keep them from scattering within the carrier.

Additionally, top lid 14 or base 24 may include attachment loops to fasten around larger objects such as skis, oars, or the like. Top lid 14 or base 24 also may include a lighting fixture that may be fixedly or removably mounted within the carrier to cast light upon the contents, and that may include a switch operated by opening or closing the doors of the carrier. Additionally or alternatively, carrier 10 may include a mirror that may be fixedly or removably mounted on interior surface 22 of doors 12. The mirror may allow a user to inspect the contents of the carrier without having to climb on top of the vehicle to which it is attached, or otherwise obtain a birds-eye view into the carrier. These additional elements are further described in Ser. No. 60/729,503 filed Oct. 21, 2005, previously incorporated by reference into the present disclosure.

Carrier 10 may include other optional elements (not shown) that facilitate mounting the carrier to a vehicle and/or transportation of the carrier to and from the vehicle. For example, handles may be located on each end and/or the sides of the carrier, allowing the carrier to be transported by hand by at least two people. Additionally or alternatively, the carrier may include wheels disposed at one end to allow a single person to transport the carrier by wheeling it along, similar to a large suitcase. Carrier 10 may also include bumpers that are adapted to prevent damage to the surface of the carrier when it is removed from a vehicle and placed onto the ground. Bumpers may be discrete elements located at each corner of the box, or they may wrap around one or both ends of the carrier, similar to the bumpers of an automobile. Each of these elements may be either fixedly attached or removably attached to the carrier.

Panels such as doors 12, central support 18, and base 24, including any ribs such as ribs 32 or 34, may be fabricated from any suitable material, including plastics or other polymers such as PC/ABS (Poly Carbonate/Acrylonitrile Butadiene Styrene), steel or other metals, carbon fiber, and the like. These panels may be fabricated from a single sheet of material that is machined, injection molded, press-molded, or manufactured by any other suitable technique. Ribs, if included, may be fabricated separately from the same material as the panels, or from different materials, and may be attached to the panels by screws, fasteners, welds, glue, and the like. In one embodiment, panels may be fabricated using a twin sheet in which two sheets of a PC/ABS material are first form-pressed to fabricate an aerodynamic exterior surface on one sheet, and any structural ribs on a second sheet. These two sheets may then be pressed together under heat and pressure to fuse the two sheets into a final panel shape. Alternatively, ribs may be formed integrally with the panels.

Car top carriers are typically mounted to the roof of a vehicle, above the head of a user. Therefore, for reasons of safety and convenience, it may be desirable to bias doors 12 towards their open position when the doors are unlatched. In FIGS. 2 and 3, carrier 10 is depicted with a scissor-style hinge that may include such a biasing mechanism to urge the doors to the open position. However, as mentioned previously, various other biasing hinge mechanisms may be suitable either alone or in combination with each other, including over-center hinge mechanisms; hinge mechanisms including one ore more gas struts; and/or hinge mechanisms including a torsion bar assembly. An over-center mechanism may, for example, be configured to exert an upward rotational biasing force on the associated door only when the door is within a predetermined range of rotational positions. When the door is outside that range, on the other hand, the over-center mechanism may be configured to exert either a downward biasing force, or to exert substantially no force. Examples of such mechanisms may be found in U.S. Provisional Patent Application Serial No. ______ filed Nov. 1, 2006 titled “Car Top Carrier Lid Support”, previously incorporated by reference into the present disclosure.

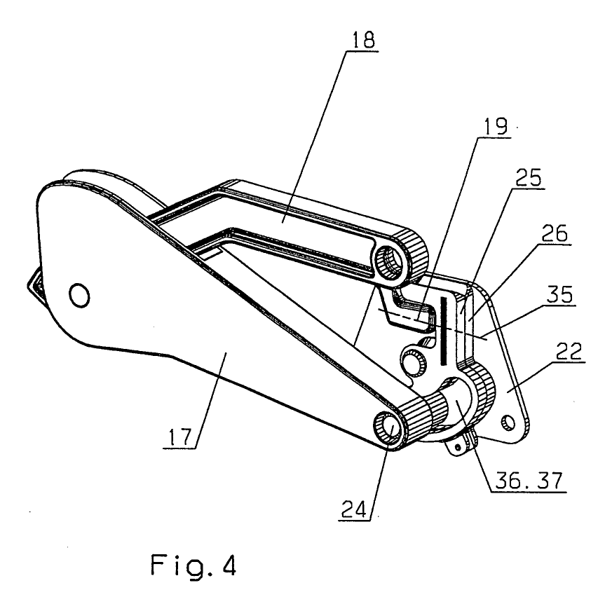

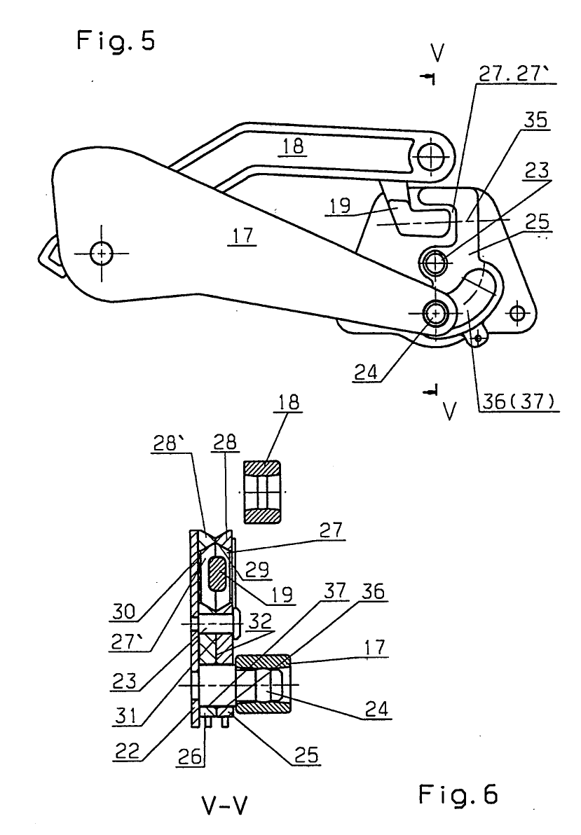

Referring now to FIGS. 4-7, an embodiment of a torsion bar assembly suitable for use with a car top carrier is depicted. FIGS. 4, 6 and 7 show a pair of torsion bar assemblies 50, 50′ suitable for use in a carrier having a pair of gull wing doors, whereas FIG. 5 shows a magnified view only of assembly 50. However, although the torsion bar assembly will be described below primarily with reference to assembly 50, the features of which are denoted in the drawings by unprimed reference numbers, it should be appreciated that assembly 50′ is substantially similar to assembly 50 and includes the same features, which are denoted in the drawings by primed reference numbers. In some embodiments, torsion bar assemblies according to the present disclosure may be adapted to bias the doors of a car top carrier toward their open position. In other embodiments, torsion bar assemblies may include a mechanism, such as an over-center mechanism, adapted to bias the doors of a carrier toward both their open and closed positions, depending upon the degree of rotation of each door relative to its corresponding aperture in the car top carrier.

Torsion bar assembly 50 includes first and second torsion bars 52, 54, and first and second mounting brackets 56, 58 that may be mounted to a portion of a car top carrier, such as a central support portion, and to which the torsion bars are respectively attached. First torsion bar 52 is shown secured to first bracket 56 by a first angled end 60 of the bar protruding through an aperture 62 formed in first bracket 56. At the other end of first torsion bar 52 is a second angled end 64 that passes through an aperture 66 formed in an adjustable pedestal 68 attached to second bracket 58, and which abuts the undersurface of a paddle 70 (see FIG. 5). Paddle 70 may be securely mounted to bracket 58, for example through alignment with and attachment to an elevated portion 72 of the bracket, and is configured to rotate about an axis passing through an aperture 74 in the paddle. Abutment of angled end. 64 of torsion bar 52 against the underside of paddle 70 is such that second angled end 64 of torsion bar 52 exerts an upward biasing force against the paddle, which tends to rotate the paddle away from bracket 58.

In an analogous manner, second torsion bar 54 is secured to second mounting bracket 58 by a first angled end 76 of the second bar protruding through an aperture 78 in second bracket 58. At the other end of second torsion bar 54 is a second angled end (not shown) that passes through an aperture 80 in an adjustable pedestal 82 attached to first bracket 56 and abuts the underside of a paddle 84, which is securely mounted to bracket 56 in the same manner that paddle 70 is mounted to bracket 58. Thus, abutment of the second angled end of torsion bar 54 exerts an upward biasing force against paddle 84 that may be approximately equal to the upward force exerted by torsion bar 52 against paddle 70, resulting in a balanced biasing force at both ends of assembly 50. However, it should be appreciated that in some embodiments, second torsion bar 54 may exert a force opposing that exerted by first bar 52, or may not be included at all. In precisely the same fashion, torsion bars 52′ and 54′ exert balanced or opposing biasing forces at both ends of assembly 50′.

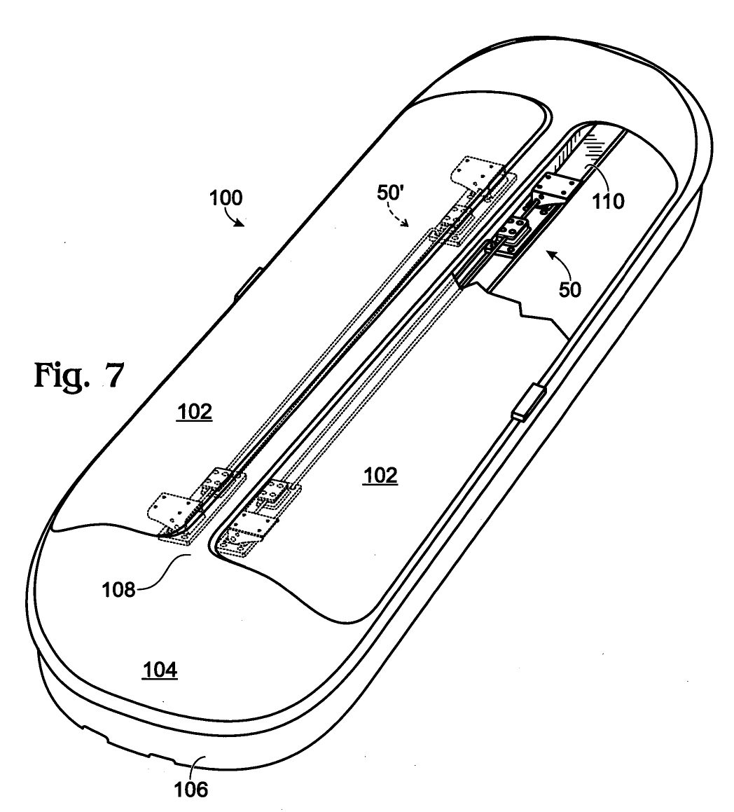

The adjustable pedestals of the torsion bar assemblies each include a plurality of apertures that may serve a dual purpose. For example, as seen in FIG. 5, pedestal 68 includes a plurality of apertures 69 through which fasteners such as screws, bolts, or the like may be inserted to attach the pedestal to bracket 58 after torsion bar 52 has been set into place against paddle 70. Furthermore, tightening or loosening the fasteners passing through the pedestal may have the effect of selectively changing the amount of compressive force the pedestal exerts against bar 52, which alters the amount of friction between the bar and aperture 66 of the pedestal (through which the bar passes). In this manner, rotational friction may be added or subtracted from the torsion bar assembly, to provide an additional mechanism for preventing abrupt and unwanted opening or closing motions of a door to which the assembly is attached (see FIGS. 6-7 and accompanying description below). Similarly, pedestal 68′ includes a plurality of apertures 69′, pedestal 82 includes a plurality of apertures 83, and pedestal 82′ includes a plurality of apertures 83′, all of which function in substantially the same manner as apertures 69 in pedestal 68.

Referring now particularly to FIGS. 6 and 7, torsion bar assemblies 50, 50′ are shown installed within a car top carrier 100. As depicted in FIGS. 6-7, carrier 100 may include gull wing doors 102, and may be substantially similar or identical to carrier 10 described previously with reference to FIGS. 1-3. FIG. 6 is a sectional end elevational view of carrier 100 showing one of doors 102 in an open position, and FIG. 7 is a semi-transparent isometric view in which carrier 100 is depicted with a portion of one of doors 102 cut away. However, although FIGS. 6-7 show carrier 100 equipped with a pair of gull wing doors each rotatably biased with a torsion bar assembly, the disclosed torsion bar assemblies also may be suitable for use with carriers having differently configured doors, including carriers having only a single gull wing door, and those having doors that rotate around axes disposed near the edges of the carrier rather than around axes disposed near a central support portion of the carrier.

In the depicted embodiment, carrier 100 includes a top lid 104 that incorporates gull wing doors 102, and a bottom 106 that may be mounted to the roof of a vehicle, for example on the crossbars of a vehicle rack. Top lid 104 includes a central support region 108, and as shown, doors 102 extend from near the junction of the top lid with bottom 106, inward toward support region 108. Support region 108 includes an internal T-shaped support structure or rib 110, the structure of which is best seen in FIG. 6. Rib 110 is configured both to reinforce the carrier and to support torsion bar assemblies 50 and 50′. As shown, support brackets 58 and 58′ of the torsion bar assemblies are disposed inside the carrier and upon each side of T-shaped rib 110, and may be securely attached to rib 110 using any suitable method such as with screws, bolts, clamps, butterfly fasteners, or the like.

Paddles 70, 70′ of the torsion bar assemblies each are attached to the corresponding one of doors 102, so that the doors rotate in conjunction with their respective paddles. In this manner, any biasing force exerted upon one of the paddles by its associated torsion bar will be transmitted to the door to which the paddle is attached. Thus if, as described previously, assembly 50 is configured so that paddles 70 and 84 each feel a balanced, upward biasing force, then the door 102 to which assembly 50 is attached (e.g., right-hand door 102 in FIG. 6) will feel a balanced upward biasing force exerted upon it by paddles 70 and 84. Similarly, the left-hand door 102 in FIG. 6 will feel an upward biasing force exerted upon it by paddles 70′ and 84′. These forces may, in some embodiments, merely assist a user in opening the doors and prevent the doors from slamming shut in an uncontrolled manner, whereas in other embodiments the biasing forces may be sufficient to cause doors 102 to open automatically (e.g., when a latch is released) and/or to remain in an open position in the absence of a closing force.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it should be within the scope of the present inventions that such disclosure or claims may be understood to include incorporation of one or more such elements, neither requiring nor excluding two or more such elements.

Applicants reserve the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A car top carrier configured to be mounted on a roof of a vehicle, the carrier comprising:
a box having a bottom, and a top lid including a pair of door apertures formed in the top lid; and
a pair of doors, wherein each door is configured to fit within one of the door apertures and is rotatably connected to the top lid with at least one hinge member, and wherein each hinge member is configured to exert an upward rotational biasing force on its associated door.

2. The car top carrier of claim 1, wherein the top lid includes a central support region, and wherein each door is connected to the central support region.

3. The car top carrier of claim 2, wherein each door is connected to the central support region with at least two hinge members.

4. The car top carrier of claim 1, wherein the hinge members are scissor-style hinge members.

5. The car top carrier of claim 1, wherein each door is rotatably connected to the top lid with a torsion bar assembly.

6. The car top carrier of claim 5, wherein the top lid includes a central support region and a rib disposed on an inner portion of the central support region, and wherein the torsion bar assemblies are attached to the rib.

7. The car top carrier of claim 6, wherein the rib is substantially T-shaped, and wherein the torsion bar assemblies are disposed upon each side of the T-shaped rib.

8. The car top carrier of claim 5, wherein each torsion bar assembly includes:
first and second mounting brackets;
a first paddle rotatably attached to the first mounting bracket and a second paddle rotatably attached to the second mounting bracket;
a first torsion bar including a first angled end inserted into an aperture of the first mounting bracket, and a second angled end abutting an underside of the second paddle such that the second angled end of the first torsion bar exerts an upward biasing force against the second paddle; and
a second torsion bar including a first angled end inserted into an aperture of the second mounting bracket, and a second angled end abutting an underside of the first paddle such that the second angled end of the second torsion bar exerts an upward biasing force against the first paddle.

9. The car top carrier of claim 8, wherein each torsion bar assembly further includes a first adjustable pedestal fixedly attached to the first mounting bracket and a second adjustable pedestal fixedly attached to the second mounting bracket, wherein the first torsion bar passes through an aperture of the second pedestal, and wherein the second torsion bar passes through an aperture of the first pedestal.

10. The car top carrier of claim 9, wherein the first adjustable pedestal is configured to allow selective adjustment of friction between the second torsion bar and the aperture of the first pedestal, and wherein the second adjustable pedestal is configured to allow selective adjustment of friction between the first torsion bar and the aperture of the second pedestal.

11. The car top carrier of claim 1, further comprising at least one gas strut associated with each door.

12. The car top carrier of claim 1, wherein each hinge member includes an over-center mechanism configured to exert an upward rotational biasing force only when the associated door is within a predetermined range of rotational positions.

13. The car top carrier of claim 1, further comprising an active water barrier formed around a perimeter of each door aperture.

14. The car top carrier of claim 1, further comprising a passive water barrier formed around a perimeter of each door aperture.

15. The car top carrier of claim a, further comprising at least one rib formed on an interior surface of each door, and wherein the ribs are configured to structurally strengthen the doors.

16. A torsion bar assembly for exerting an upward biasing force on a rotatable door, the torsion bar assembly comprising:
first and second mounting brackets;
a first paddle rotatably attached to the first mounting bracket and a second paddle rotatably attached to the second mounting bracket;
a first torsion bar including a first angled end inserted into an aperture of the first mounting bracket, and a second angled end abutting an underside of the second paddle such that the second angled end of the first torsion bar exerts an upward biasing force against the second paddle; and
a second torsion bar including a first angled end inserted into an aperture of the second mounting bracket, and a second angled end abutting an underside of the first paddle such that the second angled end of the second torsion bar exerts an upward biasing force against the first paddle.

17. The torsion bar assembly of claim 16, further comprising a first adjustable pedestal fixedly attached to the first mounting bracket and a second adjustable pedestal fixedly attached to the second mounting bracket, wherein the first torsion bar passes through an aperture of the second pedestal, and wherein the second torsion bar passes through an aperture of the first pedestal.

18. The torsion bar assembly of claim 17, wherein the first adjustable pedestal is configured to allow selective adjustment of friction between the second torsion bar and the aperture of the first pedestal, and wherein the second adjustable pedestal is configured to allow selective adjustment of friction between the first torsion bar and the aperture of the second pedestal.

19. The torsion bar assembly of claim 16, wherein the assembly is configured to be mounted within a car top carrier.

20. The torsion bar assembly of claim 19, wherein the assembly is configured to be mounted to an internal T-shaped support rib of a central support region of the carrier.
